(19) United States
(12) Patent Application Publication
(10) Pub. No.: US 2017/0226006 A1
(43) Pub. Date: Aug. 10, 2017

(54) GLASS AND MANUFACTURING METHOD OF GLASS

(71) Applicant: Asahi Glass Company, Limited, Chiyoda-ku (JP)

(72) Inventors: Masabumi ITO, Chiyoda-ku (JP); Naoaki MIYAMOTO, Chiyoda-ku (JP); Kazuya ISHIKAWA, Chiyoda-ku (JP)

(73) Assignee: Asahi Glass Company, Limited, Chiyoda-ku (JP)

(21) Appl. No.: 15/497,470

(22) Filed: Apr. 26, 2017

Related U.S. Application Data
(63) Continuation of application No. PCT/JP2015/079180, filed on Oct. 15, 2015.

(30) Foreign Application Priority Data
Oct. 28, 2014 (JP) 2014-219671
Nov. 14, 2014 (JP) 2014-231141

(51) Int. Cl. C03C 19/00; B24B 9/10

(52) U.S. Cl. CPC C03C 19/00; B24B 9/10

(57) ABSTRACT

A glass includes a first surface; a second surface that faces the first surface; at least one first end surface arranged between the first surface and the second surface; and at least one first chamfering surface connecting the first surface or the second surface with the first end surface. A surface roughness Ra of the first chamfering surface is 0.4 μm or less.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/079180 filed on Oct. 15, 2015 and designating the U.S., which claims priority of Japanese Patent Applications No. 2014-219671 filed on Oct. 28, 2014 and No. 2014-231141 filed on Nov. 14, 2014. The entire contents of the foregoing applications are incorporated herein by reference.

### BACKGROUND OF THE INVENTION

1. Field of the Invention

The present invention relates to a glass and a manufacturing method of a glass.

2. Description of the Related Art

Recently, mobile information terminals, represented by liquid crystal television, tablet type terminals or smartphones, are provided with liquid crystal display devices. A liquid crystal display device includes a sheet-like light emitting device that functions as a backlight, and a liquid crystal panel arranged on a light-emitting surface side of the sheet-like light emitting device.

The sheet-like light emitting device includes a directly under type and an edge light type. The sheet-like light emitting device of the edge light type includes a light source, a light guide plate, a reflection sheet, a diffusion sheet and the like.

A light from the light source enters the light guide plate from a light incident surface formed on a side surface of the light guide plate. On the light guide plate, a plurality of reflection dots are formed on a light reflection surface on an opposite side to the light emitting surface that faces the liquid crystal panel. The reflection sheet is arranged so as to face the light reflection surface, and the diffusion sheet is arranged so as to face the light emitting surface.

The light having entered the light guide plate from the light source proceeds while being reflected by the reflection dots and the reflection sheet, and is emitted from a light emission surface. The light emitted from the light emission surface is diffused by the diffusion sheet, and enters the liquid crystal panel.

As a material of the light guide plate, a glass having a high transmission factor and excellent heat resistance can be used (See, for example, Japanese Unexamined Patent Application Publication No. 2013-093195 and Japanese Unexamined Patent Application Publication No. 2013-030279).

A liquid crystal display device installed on a mobile information terminal or the like is desired to be thinner. With the demand for thinning the liquid crystal display device, a glass used for the light guide plate is required to be thinner.

However, when the glass is made thinner, strength of the glass decreases. Moreover, when a corner portion of the light emission surface and the light incident surface, a corner portion of the light reflection surface and the light incident surface, or the like (in the following, these corner portions will be collectively referred to as “edge portions”) has a structure of crossing at right angles, upon installing the light guide plate (glass) on the sheet-like light emitting device or the liquid crystal display device, the edge portion may contact another member and may be damaged.

Therefore, a chamfering portion is formed at the edge portion. The chamfering portion is formed by gliding the edge portion of the glass. Upon the gliding process, a cullet (glass waste) is generated from the glass. When the cullet adheres to the glass used for the light guide plate, the cullet reflects the incident light in the same way as the reflection dot.

In this way, when the incident light is reflected by the cullet, a light reflected from the cullet is emitted from the light emission surface with the reflected light that is reflected at the predetermined reflection dot. Therefore, luminance unevenness may be generated on the light emission surface, and display quality of the liquid crystal display device using the light guide plate may be degraded.

One of exemplary purposes of aspects of the present invention is to provide a glass and a manufacturing method of a glass that can reduce a generation amount of cullet.

### SUMMARY OF THE INVENTION

It is a general object of at least one embodiment of the present invention to provide a glass and a manufacturing method of a glass that substantially obviate one or more problems caused by the limitations and disadvantages of the related art.

According to an aspect of the preferred embodiment, a glass including a first surface; a second surface that faces the first surface; at least one first end surface arranged between the first surface and the second surface; and at least one first chamfering surface connecting the first surface or the second surface with the first end surface, a surface roughness Ra of the first chamfering surface being 0.4 μm or less, is provided.

Moreover, according to another aspect of the preferred embodiment, a manufacturing method of a glass including preparing a glass base material including a first surface and a second surface that face each other, and at least one first end surface and at least one second end surface that are arranged between the first surface and the second surface; chamfering the second end surface of the glass base material; performing a mirror finishing process for the first end surface; and forming at least one first chamfering surface connecting the first surface or the second surface with the first end surface by chamfering the first end surface of the glass base material that was subjected to the mirror finishing process, a surface roughness Ra of the first chamfering surface being 0.4 μm or less, is provided.

According to the embodiment of the present invention, the generation amount of cullet can be reduced, and the luminance unevenness can be prevented when the glass is used for the light guide plate.

### BRIEF DESCRIPTION OF THE DRAWINGS

Other objects and further features of embodiments will become apparent from the following detailed description when read in conjunction with the accompanying drawings, in which:

FIG. 1 is a diagram schematically depicting an example of a configuration of a liquid crystal display device in which a glass is used for a light guide plate according to an embodiment;

FIG. 2 is a diagram depicting an example of a light reflection surface of the light guide plate;

FIG. 3 is a perspective view depicting an example of the light guide plate;

FIG. 4 is a diagram for explaining a chamfering surface formed on the light guide plate;

FIG. 5 is a flowchart of a manufacturing method of a glass according to an embodiment;

FIG. 6 is a diagram for explaining a structure for disconnecting in the manufacturing method of a glass according to the embodiment;

FIG. 7 is a diagram for explaining a mirror finishing process;

FIG. 8 is a diagram depicting an example of a relation between a surface roughness of a light incident side chamfering portion and a generation amount of cullet; and

FIG. 9 is a diagram for explaining a method of measuring the generation amount of cullet.

### DESCRIPTION OF THE PREFERRED EMBODIMENTS

Next, with reference to the accompanying drawings, an exemplary embodiment of the present invention that is not restricted will be described.

In the description of the entire accompanying drawings, to the same or a corresponding member or a part, the same or a corresponding reference numeral is assigned, and duplicate explanation will be omitted. Moreover, unless particularly specified, the drawings do not aim at indicating a relative ratio between members or parts. Therefore, specific dimensions can be determined by a person skilled in the art, with reference to embodiments that are not restricted as follows.

Moreover, the embodiments which will be described as follows do not restrict the invention but are exemplary. All features and combinations thereof described in the embodiments are not necessarily essential in the present invention.

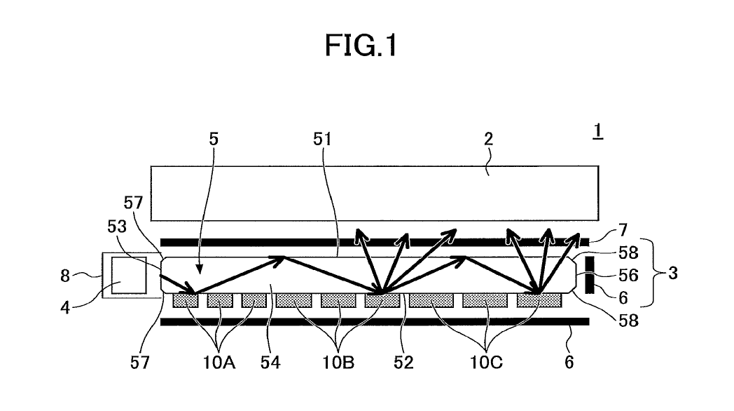

FIG. 1 is a diagram depicting an example of a liquid crystal display device 1 in which a glass is used for a light guide plate according to the embodiment of the present invention. The liquid crystal display device 1 is installed, for example, on an electronic device that has been downsized and thinned, such as a mobile information terminal.

The liquid crystal display device 1 includes a liquid crystal display panel 2 and a sheet-like light emitting device 3.

The liquid crystal panel 2 has a configuration in which an alignment layer, a transparent electrode, a glass substrate and a polarization filter are laminated so as to sandwich a liquid crystal layer arranged at the center. Moreover, on one surface of the liquid crystal layer, a color filter is arranged. Molecules in the liquid crystal layer rotate around light distribution axes by applying a driving voltage to the transparent electrode, and thereby a predetermined display is formed.

An edge-light type will be employed for the sheet-like light emitting device 3 in order to downsize and thin the sheet-like light emitting device 3. The sheet-like light emitting device 3 includes a light source 4, a light guide plate 5, a reflection sheet 6, a diffusion sheet 7, and reflection dots 10A to 10C.

Light entering the light guide plate 5 from the light source 4 proceeds while being reflected by the reflection dots 10A to 10C and the reflection sheet 6, and emitted from a light emission surface 51 that faces the liquid crystal panel 2 of the light guide plate 5. The light emitted from the light emission surface 51 is diffused by the diffusion sheet 7 and enters the liquid crystal panel 2.

The light source 4 is not particularly limited, and a hot-cathode tube, a cold-cathode tube, or an LED (Light Emitting Diode) can be used for the light source 4. The light source 4 is arranged so as to face a light incident surface 53 of the light guide plate 5.

Moreover, in order to enhance incident efficiency of light radially emitted from the light source 4 into the light guide plate 5, a reflector 8 is provided on a rear side of the light source 4.

The reflection sheet 6 has a configuration in which a light reflecting member is applied on a surface of a resin sheet such as an acrylic resin. The reflection sheet 6 is arranged on a light reflection surface 52 and non-light incident surfaces 54-56. The light reflection surface 52 is an opposite surface to the light emission surface 51 of the light guide plate 5. The non-light incident surfaces 54-56 are end surfaces of the light reflection surface 52 except for the light incident surface 51. When the incident efficiency is not required to be enhanced particularly, the reflection sheet 6 may not be arranged on the non-light incident surfaces 54-56.

For the diffusion sheet 7, a translucent white acrylic resin film or the like may be used. Because the diffusion sheet diffuses the light emitted from the light emission surface 51 of the light guide plate 5, the rear surface side of the liquid crystal panel 2 can be irradiated with uniform light free from luminance unevenness. The reflection sheet 6 and the diffusion sheet 7 are fixed at a predetermined position of the light guide plate 5 by bonding, for example.

Next, the light guide plate 5 will be explained.

The light guide plate 5 is formed of a glass having a high transparency. In the embodiment, for a material of the glass used for the light guide plate 5, multicomponent oxide glass is used.

Specifically, for the light guide plate 5, a glass member, in which an effective optical path length is 5 to 200 cm, an average internal transmittance in the visible light region (wavelength of 350 nm to 780 nm) at the effective optical path length is 80% or more, and a Y-value of a tri-stimulus in an XYZ color system of JIS Z8701 (ANNEX) is 90% or more, is used. The Y-value is obtained by Y=Σ(S(λ)×y(λ)), where S(λ) is a transmittance at each wavelength λ, and y(λ) is a weight coefficient for each wavelength. Therefore, Σ(S(λ)×y(λ)) is a sum of a product of the weight coefficient at each wavelength and the transmittance thereof. The coefficient y(λ) corresponds to an M cone (G cone/green) of the eye retina cell, and responds best to light with wavelength of 535 nm. The average internal transmittance in the visible light region is preferably 82% or more at the effective optical path length, more preferably 85% or more, and further preferably 90% or more. The Y value is preferably 91% or more at the effective optical path length, more preferably 92% or more, and further preferably 93% or more.

Moreover, in another expression, the average internal transmittance of the glass at a wavelength of 400 nm to 700 nm under the condition of the effective optical path length of 50 mm is preferably 90% or more. According to this configuration, the light entering the glass can be prevented from attenuating as much as possible. The average internal transmittance at a wavelength of 400 nm to 700 nm under the condition of the effective optical path length of 50 mm is preferably 92% or more, and more preferably 95% or more, further preferably 98% or more, and especially preferably 99% or more.

The average internal transmittance of the glass at a wavelength of 400 nm to 700 nm under the condition of the effective optical path length of 50 mm can be measured using the following method. First, by cutting a glass in a direction orthogonal to the main surface, a sample S_{A} can be obtained from a central portion of the glass, having a dimension of 50 mm vertical×50 mm horizontal, and having a first cutting surface and a second cutting surface (end surfaces) that face each other, which have an arithmetic average roughness Ra≦0.03 μm. For this sample S_{A}, at a length of 50 mm in the normal direction from the first cutting surface, the measurement is performed using a UV-Visible-NIR Spectrophotometer (UH4150, Hitachi High-Technologies Corporation), with the incident light whose beam width is made narrower than a plate thickness by using a slit or the like. From the transmittance obtained in this way under the condition of the effective optical length of 50 mm, by removing a loss due to a reflection on the surface, the internal transmittance under the effective optical length of 50 mm can be obtained.

A total amount A of a content of iron in the glass used for the light guide plate 5 is preferably 100 mass ppm or less so as to meet the above-described internal transmittance at a wavelength of 400 nm to 700 nm, more preferably 40 mass ppm or less, and further preferably 20 mass ppm or less. A total amount A of a content of iron in a glass used for a glass plate is preferably 5 mass ppm or more so as to enhance solubility of the glass upon manufacturing a multicomponent oxide glass, more preferably 8 mass ppm or more, and further preferably 10 mass ppm or more. The total amount A of the content of iron in the glass used for the light guide plate 5 can be controlled by an amount of iron added upon manufacturing the glass.

In the specification, a total amount of content of iron in a glass is indicated as content of Fe₂O₃. However, all irons existing in the glass do not always exist as Fe³⁺ (trivalent iron). Usually, in a glass, Fe³⁺ and Fe²⁺ (divalent iron) exist simultaneously. Fe²⁺ and Fe³⁺ have absorption coefficients within a range of a wavelength of 400 nm to 700 nm. Because the absorption coefficient of Fe²⁺ (11 cm⁻¹ Mol⁻¹) is an order of magnitude greater than the absorption coefficient of Fe³⁺ (0.96 cm⁻¹ Mol⁻¹), Fe²⁺ decreases the internal transmittance in the range of a wavelength of 400 nm to 700 nm. Therefore, small content of Fe²⁺ is preferable so as to enhance the internal transmittance in the range of a wavelength of 400 nm to 700 nm.

Content B of Fe²⁺ in the glass used for the light guide plate 5 is preferably 20 mass ppm or less so as to meet the above-described internal transmittance at a wavelength of 400 nm to 700 nm, more preferably 10 mass ppm or less, and further preferably 5 mass ppm or less. A content B of Fe²⁺ in a glass used for the light guide plate 5 is preferably 0.01 mass ppm or more so as to enhance solubility of the glass upon manufacturing a multicomponent oxide glass, more preferably 0.05 mass ppm or more, and further preferably 0.1 mass ppm or more.

The content B of Fe²⁺ in the glass used for the light guide plate 5 can be controlled by an amount of an oxidation agent added upon manufacturing the glass, a dissolution temperature or the like. Specific kind of oxidation agent and an additive amount thereof added upon manufacturing the glass will be described later. The content A of Fe₂O₃ is content of all irons (mass ppm) that are converted into Fe₂O₃ obtained by the fluorescence X-ray measurement. The content B of Fe²⁺ was measured according to the ASTM C169-92 (2011). The measured content B of Fe²⁺ is indicated by converting into Fe₂O₃.

Preferred specific examples of a composition of the glass used for the light guide plate 5 will be depicted as follows. However, the composition of the glass used for the light guide plate 5 is not limited to them.

A configuration example of the glass used for the light guide plate 5 (configuration example E_{A}) includes, in percent by mass in terms of oxide, SiO₂ of 60% to 80%; Al₂O₃ of 0% to 7%; MgO of 0% to 10%; CaO of 0% to 20%; SrO of 0% to 15%; BaO of 0% to 15%; Na₂O of 3% to 20%; K₂O of 0% to 10%; and Fe₂O₃ of 5 mass ppm to 100 mass ppm.

Another configuration example of the glass used for the light guide plate 5 (configuration example E_{B}) includes, in percent by mass in terms of oxide, SiO₂ of 45% to 80%; Al₂O₃ of greater than 7% but less than or equal to 30%; B₂O₃ of 0% to 15%; MgO of 0% to 15%; CaO of 0% to 6%; SrO of 0% to 5%; BaO of 0% to 5%; Na₂O of 7% to 20%; K₂O of 0% to 10%; ZrO₂ of 0% to 10%; and Fe₂O₃ of 5 mass ppm to 100 mass ppm.

Yet another configuration example of the glass used for the light guide plate 5 (configuration example E_{C}) includes, in percent by mass in terms of oxide, SiO₂ of 45% to 70%; Al₂O₃ of 10% to 30%; B₂O₃ of 0% to 15%; MgO, CaO, SrO, and BaO of 5% to 30% in total; Li₂O, Na₂O, and K₂O of greater than or equal to 0% but less than 3% in total; and Fe₂O₃ of 5 mass ppm to 100 mass ppm.

A composition ranges of the respective components of the composition of the glass used for the light guide plate 5 according to the embodiment having the above-described components will be described as follows. Units of contents of any of the respective compositions are percent by mass in terms of oxide or mass ppm, which are simply indicated by “%” or “ppm”.

SiO₂ is a main component of glass. In order to maintain weather resistance and a devitrification characteristic, a content of SiO₂ is, in percent by mass in terms of oxide, for the configuration example E_{A}, preferably 60% or more, and more preferably 63% or more; for the configuration example E_{B}, preferably 45% or more, and more preferably 50% or more; and for the configuration example E_{C}, preferably 45% or more, and more preferably 50% or more.

In order to allow easy dissolution and improve foam quality, and moreover in order to keep the content of bivalent iron (Fe²⁺) in a glass low to improve an optical characteristic, the content of SiO₂ is, for the configuration example E_{A}, preferably 80% or less, and more preferably 75% or less; for the configuration example E_{B}, preferably 80% or less, and more preferably 70% or less; and for the configuration example E_{C}, preferably 70% or less, and more preferably 65% or less.

Al₂O₃ is an essential component in the configuration examples E_{B} and E_{C}, in order to improve the weather resistance. In order to maintain the weather resistance required for the practical use in the glass according to the embodiment, a content of Al₂O₃ is, for the configuration example E_{A}, preferably 1% or more, and more preferably 2% or more; for the configuration example E_{B}, preferably greater than 7%, and more preferably 10% or more; and for the configuration example E_{C}, preferably 10% or more, and more preferably 13% or more.

However, in order to keep the content of bivalent iron (Fe²⁺) in a glass low to improve the optical characteristic, and in order to improve the foam quality, the content of Al₂O₃ is, for the configuration example E_{A}, preferably 7% or less, and more preferably 5% or less; for the configuration example E_{B}, preferably 30% or less, and more preferably 23% or less; and for the configuration example E_{C}, preferably 30% or less, and more preferably 20% or less.

B₂O₃ is a component for advancing melting of a glass raw material and enhancing a mechanical characteristic or weather resistance. In order to prevent reaming due to volatilization from being generated or inconvenience such as erosion of a furnace wall from occurring, a content of B₂O₃ is, for the configuration example E_{A}, preferably 5% or less, and more preferably 3% or less; for the configuration examples E_{B} and E_{C}, preferably 15% or less, and more preferably 12% or less.

An alkali metal oxide, such as Li₂O, Na₂O and K₂O, is a useful component for advancing melting of a glass raw material, and controlling heat expansion, viscosity or the like.

Therefore, a content of Na₂O is, for the configuration example E_{A}, preferably 3% or more, and more preferably 8% or more. The content of Na₂O is, for the configuration example E_{B}, preferably 7% or more, and more preferably 10% or more. However, in order to maintain high clarity upon dissolving to keep the foam quality of a manufactured glass, the content of Na₂O is, for the configuration examples E_{A} and E_{B}, preferably 20% or less, and more preferably 15% or less. The content of Na₂O is, for the configuration example E_{C}, more preferably 3% or less, and more preferably 1% or less.

Moreover, a content of K₂O is, for the configuration examples E_{A} and E_{B}, preferably 10% or less, and more preferably 7% or less. The content of K₂O is, for the configuration example E_{C}, preferably 2% or less, and more preferably 1% or less.

Moreover, Li₂O is an optional component. Because Li₂O allows easy vitrification, keeps low the content of iron that is included as an impurity derived from a raw material, and keeps a batch cost low, Li₂O of 2% or less can be included in the configuration examples E_{A}, E_{B} and E_{C}.

Moreover, a total content of the alkali metal oxides (Li₂O, Na₂O, and K₂O) is, in order to maintain high clarity upon dissolving to keep the foam quality of a manufactured glass, for the configuration examples E_{A} and E_{B}, preferably 5% to 20%, and more preferably 8% to 15%. The total content is, for the configuration example E_{C}, preferably 0% to 2%, and more preferably 0% to 1%.

Alkali earth metal oxides, such as MgO, CaO, SrO and BaO, are useful components for advancing melting of a glass raw material, and controlling heat expansion, viscosity or the like.

MgO has effects of decreasing viscosity upon dissolution of a glass and advancing the dissolution. Moreover, because MgO has an effect of reducing specific weight and preventing a glass plate from being damaged, MgO can be included in the configuration examples E_{A}, E_{B} and E_{C}. Moreover, in order to keep a low thermal expansion coefficient of a glass, and improve a devitrification characteristic, a content of MgO is, for the configuration example E_{A}, preferably 10% or less, and more preferably 8% or less, for the configuration example E_{B}, preferably 15% or less, and more preferably 12% or less, and for the configuration example E_{C}, preferably 10% or less, and more preferably 5% or less.

Because CaO is a component for advancing melting of a glass raw material and controlling viscosity, heat expansion or the like, CaO can be included in the configuration example E_{A}, E_{B} and E_{C}. In order to obtain the above-described effects, in the configuration example E_{A}, a content of CaO is preferably 3% or more, and more preferably 5% or more. Moreover, in order to improve devitrification, for the configuration example E_{A}, the content of CaO is preferably 20% or less, and more preferably 10% or less, and for the configuration example E_{B}, preferably 6% or less, and more preferably 4% or less.

SrO has effects of increasing a thermal expansion coefficient and reducing a high-temperature viscosity of a glass. In order to obtain the effects, SrO can be included in the configuration examples E_{A}, E_{B} and E_{C}. However, in order to keep the thermal expansion coefficient of a glass low, a content of SrO is, for the configuration examples E_{A} and E_{C}, preferably 15% or less, and more preferably 10% or less, and for the configuration example E_{B}, preferably 5% or less, and more preferably 3% or less.

BaO has effects of increasing a thermal expansion coefficient and reducing a high-temperature viscosity of a glass, similarly to SrO. In order to obtain the effects, BaO can be included in the configuration examples E_{A}, E_{B} and E_{C}. However, in order to keep the thermal expansion coefficient of a glass low, a content of BaO is, for the configuration examples E_{A} and E_{C}, preferably 15% or less, and more preferably 10% or less, and for the configuration example E_{B}, preferably 5% or less, and more preferably 3% or less.

Moreover, a total content of the alkali earth metal oxides (MgO, CaO, SrO, and BaO) is, in order to keep a low thermal expansion coefficient of a glass, and improve a devitrification characteristic, the total content is, for the configuration example E_{A}, preferably 10% to 30%, and more preferably 13% to 27%, for the configuration example E_{B}, preferably 1% to 15%, and more preferably 3% to 10%, and for the configuration example E_{C}, preferably 5% to 30%, and more preferably 10% to 20%.

For the glass composition of the glass used for the light guide plate according to the embodiment, in order to improve heat resistance and surface hardness of a glass, ZrO₂ may be included in the configuration examples E_{A}, E_{B}, and E_{C}, as an optional component. The content of ZrO₂ is preferably 10% or less, and more preferably 5% or less. By making the content of ZrO₂ 10% or less, the glass becomes difficult to devitrify.

For the glass composition of the glass used for the light guide plate 5 according to the embodiment, in order to enhance solubility of the glass, Fe₂O₃ may be included in the configuration examples E_{A}, E_{B} and E_{C}. The content of Fe₂O₃ is preferably 5 ppm to 100 ppm.

Moreover, the glass used for the light guide plate 5 according to the embodiment may include SO₃ as a fining agent. In this case, a content of SO₃ is, in percent by mass, preferably greater than 0% but less than or equal to 0.5%. The content of SO₃ is more preferably 0.4% or less, further preferably 0.3% or less, and further preferably 0.25% or less.

Moreover, the glass used for the light guide plate 5 according to the embodiment may include one or more of Sb₂O₃, SnO₂, and As₂O₃ as an oxidation agent and a fining agent. In this case, a content of one or more of Sb₂O₃, SnO₂, and As₂O₃ is, in percent by mass, preferably 0% to 0.5%. The content of one or more of Sb₂O₃, SnO₂, and As₂O₃ is more preferably 0.2% or less, and further preferably 0.1% or less. Further preferably, the glass does not include substantially Sb₂O₃, SnO₂, or As₂O₃.

However, because Sb₂O₃, SnO₂, and As₂O₃ effect as an oxidation agent for a glass, Sb₂O₃, SnO₂, and As₂O₃ may be added within the above-described range for the purpose of controlling the amount of Fe²⁺ in the glass. However, As₂O₃ is not preferably included substantially from an environmental point of view.

Moreover, the glass used for the light guide plate 5 according to the embodiment may include NiO. In the case of including NiO, because NiO also functions as a coloring component, a content of NiO is preferably 10 ppm or less with respect to the total quantity of the above-described glass composition. Particularly, from the standpoint of not decreasing the internal transmittance of the glass plate at a wavelength of 400 nm to 700 nm, the content of NiO is preferably 1.0 ppm or less, and more preferably 0.5 ppm or less.

The glass used for the light guide plate 5 according to the embodiment may include Cr₂O₃. In the case of including Cr₂O₃, because Cr₂O₃ also functions as a coloring component, a content of Cr₂O₃ is preferably 10 ppm or less with respect to the total quantity of the above-described glass composition. Particularly, from the standpoint of not decreasing the internal transmittance of the glass plate at a wavelength of 400 nm to 700 nm, the content of Cr₂O₃ is preferably 1.0 ppm or less, and more preferably 0.5 ppm or less.

The glass used for the light guide plate 5 according to the embodiment may include MnO₂. In the case of including MnO₂, because MnO₂ also functions as a component for absorbing visible light, a content of MnO₂ is preferably 50 ppm or less with respect to the total quantity of the above-described glass composition. Particularly, from the standpoint of not decreasing the internal transmittance of the glass plate at a wavelength of 400 nm to 700 nm, the content of MnO₂ is preferably 10 ppm or less.

The glass used for the light guide plate 5 according to the embodiment may include TiO₂. In the case of including TiO₂, because TiO₂ also functions as a component for absorbing visible light, a content of TiO₂ is preferably 1000 ppm or less with respect to the total quantity of the above-described glass composition. Particularly, from the standpoint of not decreasing the internal transmittance of the glass plate at a wavelength of 400 nm to 700 nm, the content of TiO₂ is preferably 500 ppm or less, and especially preferably 100 ppm or less.

The glass used for the light guide plate 5 according to the embodiment may include CeO₂. CeO₂ has an effect of decreasing a redox of iron, and can reduce a proportion of the amount of Fe²⁺ to the total amount of iron. Also in order to prevent the redox of iron from becoming smaller than 3%, the content of CeO₂ is preferably 1000 ppm or less with respect to the total quantity of the above-described glass composition. Moreover, the content of CeO₂ is more preferably 500 ppm or less, further preferably 400 ppm or less, especially preferably 300 ppm or less, and most preferably 250 ppm or less.

The glass used for the light guide plate 5 according to the embodiment may include at least one component selected from a group including CoO, V₂O₅, and CuO. In the case of including the components, because the components also function as components for absorbing visible light, the content of the components is preferably 10 ppm or less with respect to the total quantity of the above-described glass composition. Particularly, the glass preferably does not include the components substantially so as not to decrease the internal transmittance of the glass plate at a wavelength of 400 nm to 700 nm.

However, the glass used for the light guide plate 5 is not limited to the above-described glass.

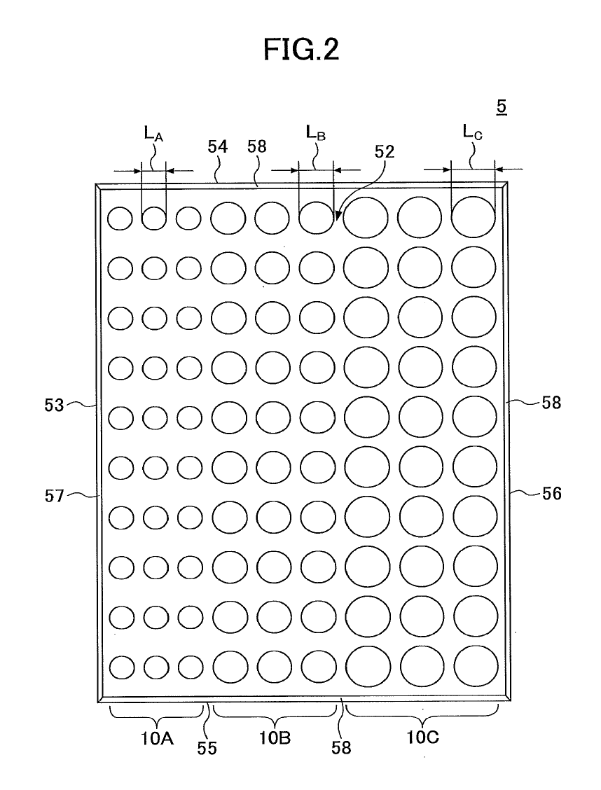

The light guide plate 5 includes, as illustrated in FIGS. 2-4 in addition to FIG. 1, the light emission surface 51 (first surface), the light reflection surface 52 (second surface), the light incident surface 53 (first end surface), the non-light incident surfaces 54-56 (second end surfaces), a light incident side chamfering surface 57 (first chamfering surface), and a non-light incident side chamfering surface 58 (second chamfering surface).

The light emission surface 51 is a surface that faces the liquid crystal panel 2. In the embodiment, the light emission surface 51 has a rectangular shape in a planar view (in a state of viewing the light emission surface 51 from above). However, the shape of the light emission surface 51 is not limited to rectangular.

Because a size of the light emission surface 51 is determined corresponding to the liquid crystal panel 2, the size is not particularly limited. The size is preferably 300 mm×300 mm or greater, and more preferably 500 mm×500 mm or greater. Because the light guide plate 5 has a high rigidity, the greater the size is, the more prominent the effect is.

The light reflection surface 52 is a surface that faces the light emission surface 51. The light reflection surface 52 is formed so as to be parallel to the light emission surface 51. Moreover, a shape and a size of the light reflection surface 52 are the same as those of the light emission surface 51.

However, the light reflection surface 52 is not necessarily parallel to the light emission surface 51. The light reflection surface 52 may include a configuration provided with difference in level or a slope. Moreover, the size of the light reflection surface 52 may be different from the size of the light emission surface 51.

On the light reflection surface 52, as illustrated in FIG. 2, reflection dots 10A-10C are formed. The reflection dots 10A-10C are obtained by printing a white ink in shapes of dots. Luminance of light entering from the light incident surface 53 is high, but the luminance is decreased as the light proceeds while being reflected in the light guide plate 5.

Therefore, in the embodiment, along the traveling direction of the light from the light incident surface 53 (in a direction from left to right in FIGS. 1 and 2), sizes of the reflection dots 10A-10C are made different. Specifically, a diameter (L_{A}) of the reflection dots 10A in a region near the light incident surface 53 is set small. A diameter (L_{B}) of the reflection dots 10B and a diameter (L_{C}) of the reflection dots 100 are set so that the diameter becomes greater along the traveling direction of the light from the region near the light incident surface 53 (i.e. L_{A}<L_{B}<L_{C}).

In this way, by changing the size of the respective reflection dots 10A along the traveling direction of the light in the light guide plate 5, the luminance of emission light emitted from the light emission surface 51 can be made uniform, and luminance unevenness can be prevented from occurring. In addition, also by changing a number density of the respective reflection dots 10A along the traveling direction of the light in the light guide plate 5, instead of the size of the respective reflection dots 10A, a similar effect can be obtained. Moreover, also by forming a groove that reflects the incident light on the light reflection surface 52 instead of the reflection dots 10A, the similar effect can be obtained.

In the embodiment, four end surfaces are formed between the light emitting surface 51 and the light reflection surface 52. Among the four end surfaces, the light incident surface 53 that is the first end surface is a surface which light enters from the light source 4. The non-light incident surfaces 54-56 that are the second to fourth end surfaces are surfaces which light does not enter from the light source 4.

The light incident surface 53 is preferably subjected to a mirror finishing process upon manufacturing a glass that forms the light guide plate 5. Specifically, an arithmetic average roughness Ra on a surface of the light incident surface 53 (center line average roughness) is preferably less than 0.10 μm, more preferably less than 0.03 μm, further preferably less than 0.01 μm, and especially preferably less than 0.005 μm. Therefore, a light incident efficiency of light entering the light guide plate 5 from the light source 4 is enhanced. A thickness of the light incident surface 53 (indicated by an arrow W in FIG. 4) is set to a thickness required by the liquid crystal display device 1, in which the sheet-like light emitting device 3 is installed.

In the following description, the surface roughness Ra is assumed to be referred to as an arithmetic average roughness (center line average roughness) according to JIS B 0601 to JIS B 0031.

A light incident side chamfering surface 57 is formed between the light emission surface 51 and the light incident surface 53, and between the light reflection surface 52 and the light incident surface 53.

In the embodiment, an example is illustrated in which the light incident side chamfering surfaces 57 are formed both between the light emission surface 51 and the light incident surface 53 and between the light reflection surface 52 and the light incident surface 53. However, the light incident side chamfering surface 57 may be formed either one of the two.

In the sheet-like light emitting device 3, which is required to be downsized and thinned, as illustrated in the embodiment, the light guide plate 5 is preferably made thinner. Therefore, the thickness of the light guide plate 5 according to the embodiment is 10 mm or less. However, in the case where the light guide plate 5 is not provided with the light incident side chamfering surface 57 but a corner portion is present, when the light guide plate 5 is installed in the sheet-like light emitting device 3, or the like, the corner portion may contact another member and be damaged. In this case, strength of the light guide plate 5 may be decreased. Therefore, the light guide plate 5 according to the embodiment has the thickness of 0.5 mm or more. Furthermore, the light incident side chamfering surfaces 57 are formed on an upper edge and a lower edge of the light incident surface 53.

The thickness of the light guide plate is preferably 0.7 mm or more, further preferably 1.0 mm or more, and further preferably 1.5 mm or more. When the thickness of the light guide plate 5 is 0.7 mm or more, a sufficient stiffness is obtained. Moreover, the thickness of the light guide plate 5 is more preferably 3.0 mm or less. This configuration contributes to the thinning of the surface light emitting illuminating device.

In order to enhance the light incident efficiency of the light from the light source 4 to the light guide plate 5, an area of the light incident surface 53 is required to be great. Therefore, the light incident side chamfering surface 57 is preferably small. In the embodiment, a chamfering process is performed as the light incident side chamfering surface 57.

When a width dimension of the light incident side chamfering surface 57 (chamfering surface) is denoted as X mm, as illustrated in FIG. 4, an average value Xₐᵥₑ in a chamfering surface longitudinal direction of the width dimension X (in the following, simply referred to as longitudinal direction) is 0.1 mm. Xₐᵥₑ is preferably within the range of 0.1 mm to 0.5 mm. When Xₐᵥₑ is 0.5 mm or less, the width dimension of the light incident surface can be increased. When Xₐᵥₑ is 0.1 mm or more, an error in X, which will be described later, can be made smaller.

Actually, an error resulting from an unevenness of processing upon the chamfering processing in the longitudinal direction arises in the width dimension X of the light incident side chamfering surface 57. In FIG. 4, an error in the width dimension X of the light incident side chamfering surface 57 is 0.05 mm or less. In this way, when the average value of the width dimension X of the light incident side chamfering surface 57 in the longitudinal direction is Xₐᵥₑ mm, the error of X in the longitudinal direction is preferably 50% of Xₐᵥₑ or less. That is, X preferably satisfies the relation 0.5 Xₐᵥₑ≦X≦1.5 Xₐᵥₑ. The error of X in the longitudinal direction is more preferably 40% of Xₐᵥₑ or less, further preferably 30% of Xₐᵥₑ or less, and especially preferably 20% of Xₐᵥₑ or less. According to the above-described configuration, because errors in the width dimension of the light incident side chamfering surface 57 and a width dimension of the light incident surface 53 in the longitudinal direction become smaller, a luminance unevenness occurring in the light guide plate 5 can be made smaller.

Moreover, the surface roughness Ra of the light incident side chamfering surface 57 is 0.4 μm or less. The reason why the surface roughness Ra of the light incident side chamfering surface 57 is 0.4 μm or less will be described later for the purpose of illustration. The surface roughness Ra of the light incident side chamfering surface 57 is preferably 0.1 μm or less, more preferably 0.05 μm or less, and further preferably less than 0.03 μm.

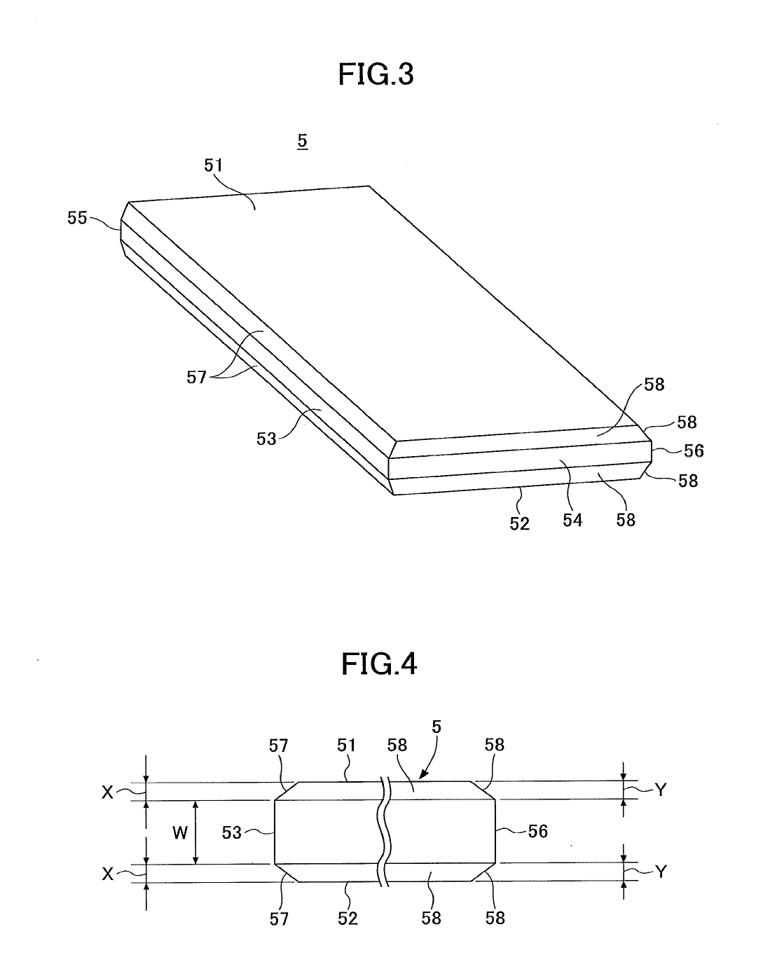

Moreover, in the embodiment, as illustrated in FIG. 3, non-light incident side chamfering surfaces 58 are formed all between the light emission surface 51 and the non-light incident surface 54, between the light reflection surface 52 and non-light incident surface 54, between the light emission surface 51 and the non-light incident surface 55, between the light reflection surface 52 and non-light incident surface 55, between the light emission surface 51 and the non-light incident surface 56, and between the light reflection surface 52 and non-light incident surface 56. However, the non-light incident side chamfering surfaces 28 are not necessarily required to be formed at all the above-described locations, but the non-light incident side chamfering surface 58 may be formed selectively.

When a width dimension of the non-light incident side chamfering surface 58 is denoted as Y mm, as illustrated in FIG. 4, an average value Yₐᵥₑ in the longitudinal direction is within the range of 0.1 mm to 0.6 mm. When Yₐᵥₑ is 0.6 mm or less, the width dimensions of the non-light incident surfaces 54-56 can be increased. When Yₐᵥₑ is 0.1 mm or more, an error in Y, which will be described later, can be made smaller.

An error resulting from an unevenness of processing upon the chamfering processing in the longitudinal direction arises in the width dimension Y of the non-light incident side chamfering surface 58. When the average value of Y in the longitudinal direction is Yₐᵥₑ mm, the error of Y in the longitudinal direction is preferably 50% of Yₐᵥₑ or less. That is, Y preferably satisfies the relation 0.5 Yₐᵥₑ≦Y≦1.5 Yₐᵥₑ. The error of Y in the longitudinal direction is more preferably 40% of Yₐᵥₑ or less, further preferably 30% of Yₐᵥₑ or less, and especially preferably 20% of Yₐᵥₑ or less. According to the above-described configuration, because errors in the width dimensions of the non-light incident surfaces 54-56, on which incident light is reflected, in the longitudinal direction become smaller, a luminance unevenness occurring in the light guide plate 5 can be made smaller.

Moreover, the surface roughness Ra of the non-light incident side chamfering surface 58 can be made greater than the surface roughness Ra of the light incident side chamfering surface 57. In this case, the surface roughness Ra of the light incident side chamfering surface 57 is preferably 0.4 μm or more. Moreover the surface roughness Ra of the non-light incident side chamfering surface 58 is preferably 1.0 μm or less.

Because light from the light source 4 does not enter the non-light incident surfaces 54-56 on which the non-light incident side chamfering surfaces 58 are formed, surfaces of the non-light incident surfaces 54-56 are not required to be processed with a high accuracy. Therefore, the surface roughness Ra of the non-light incident side chamfering surface 58 is set greater than the case of the light incident side chamfering surface 57, the processing of the non-light incident side chamfering surface 58 becomes easier than the light incident side chamfering surface 57, and thereby productivity can be enhanced. Furthermore, because the surface roughness Ra of the non-light incident side chamfering surface 58 is 0.4 μm or more but 1.0 μm or less, when the reflection sheet 6 adheres to the non-light incident side chamfering surface 58, adhesiveness between them becomes excellent. When the productivity is not taken into account, the surface roughness Ra of the non-light incident side chamfering surface 58 is preferably less than 0.4 μm, from a standpoint of preventing a crack from occurring.

Moreover, the surface roughness Ra of the non-light incident surfaces 54-56 is 1.5 μm or less. The surface roughness Ra of the non-light incident surfaces 54-56 is preferably 1.0 μm or less, and more preferably 0.8 μm or less.

Moreover, in the embodiment, a polishing process is not performed for the non-light incident surfaces 54-56. Therefore, the surface roughness Ra of the non-light incident surfaces 54-56 are set greater than the surface roughness Ra of the light incident surface 53. The surface roughness Ra of the non-light incident surfaces 54-56 is preferably 0.03 μm or more, and more preferably 0.1 μm or more. According to the above-described configuration, the processing for the non-light incident surfaces 54-56 becomes easier than the light incident surface 53, or the processing becomes unnecessary, and thereby the productivity is enhanced. However, the polishing process may be performed for the non-light incident surfaces 54-56.

Next, a manufacturing method of the glass, of which the light guide plate 5 is formed, will be described.

FIGS. 5 to 7 are diagrams for explaining a manufacturing method of the light guide plate 5. FIG. 5 is a flowchart depicting the manufacturing method of the light guide plate 5.

In order to manufacture the light guide plate 5, first, a glass material 12 is prepared. The glass material 12 has an effective optical path length of 5 cm to 200 cm, a thickness of 0.5 mm to 10 mm, an average internal transmittance in the visible light region of 80% or more, and a Y-value of a tri-stimulus in an XYZ color system of JIS 28701 (ANNEX) of 90% or more, as described above. The glass material 12 has a greater shape than a predetermined shape of the light guide plate 5.

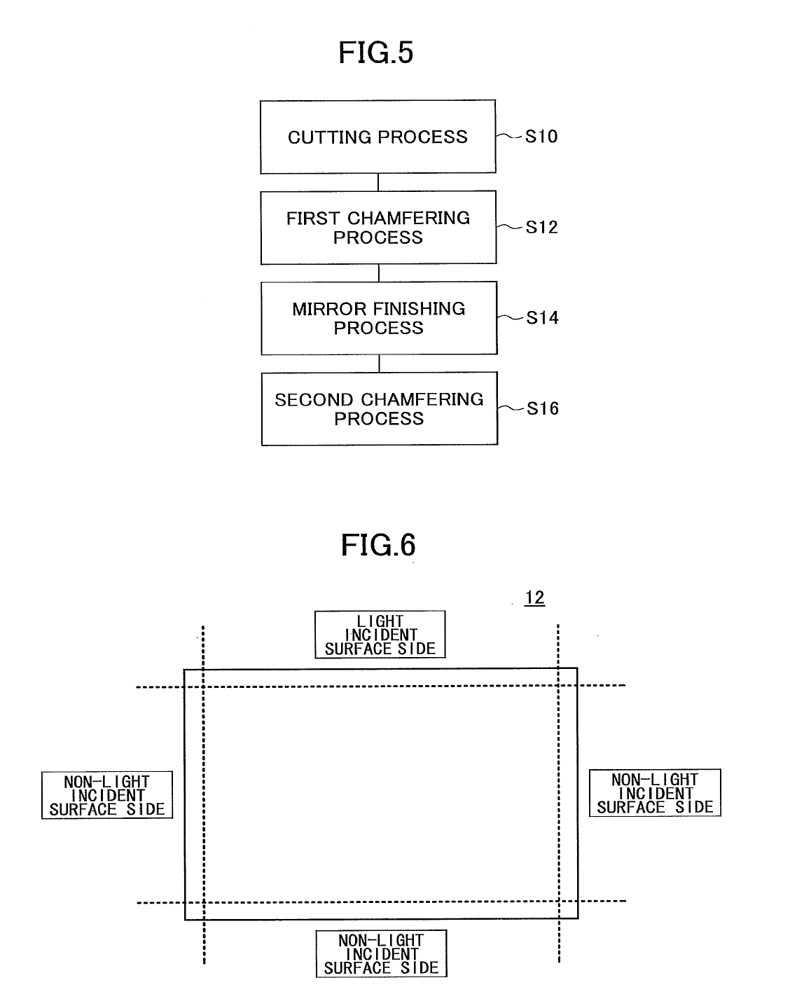

The glass material 12 is first subjected to a cutting process indicated by step S10 in FIG. 5. In the cutting process, a cutting processing treatment is performed at the respective positions (one light incident side position, and three non-light incident side positions) indicated by dashed lines in FIG. 6 by using a cutting apparatus. The cutting processing treatment is not necessarily performed at the three non-light incident side positions, but may be performed only at one non-light incident side position that faces one light incident side position.

By performing the cutting processing treatment, a glass base material 14 is cut from the glass material 12. In the embodiment, because the light guide plate 5 has a rectangular shape in a planar view, the cutting processing treatment is performed for one light incident side position and three non-light incident side positions. However, the cutting position is appropriately selected according to the shape of the light guide plate 5.

When the cutting processing treatment ends, a first chamfering process (step S12) is performed. In the first chamfering process, by using the cutting device, non-light incident side chamfering surfaces 58 are formed both between the light emission surface 51 and the non-light incident surface 56 and between the light reflection surface 52 and the non-light incident surface 56.

When the non-light incident side chamfering surface 58 is formed for all of or any one of between the light emission surface 51 and the non-light incident surface 54, between the light reflection surface 52 and the non-light incident surface 54, between the light emission surface 51 and the non-light incident surface 55, and between the light reflection surface 52 and the non-light incident surface 55, a chamfering processing treatment is performed at the first chamfering process.

Moreover, in the first chamfering process, a chamfering process may be performed between the light emission surface 51 and the light incident surface 53 or between the light reflection surface 52 and the light incident surface 53. In this case, a surface roughness Ra of the chamfering surface, obtained as above, is preferably greater than a surface roughness Ra of the light incident side chamfering surface 57, obtained in a second chamfering process, described later, from the standpoint of productivity.

Moreover, in the embodiment, the cutting process or the polishing process is performed for the non-light incident surfaces 54-56 at the first chamfering step. The cutting process or the polishing process for the non-light incident surfaces 54-56 may be performed before, after, or simultaneously with forming the non-light incident side chamfering surface 58. Moreover, regarding the non-light incident surfaces 54, 55, surfaces obtained by performing the cutting processing treatment may be used as the non-light incident surfaces 54, 55.

The first chamfering process (step S12) may be performed simultaneously with or after a mirror finishing process (step S14), which will be described later, and the second chamfering step (step S16). However, the first chamfering process is preferably performed before the processes at steps S14 and S16. Then, because the process according to the shape of the light guide plate 5 can be performed at a relatively fast rate at step S12, the productivity is enhanced and it becomes difficult for a relatively large cullet generated at step S12 to damage the light incident surface 53 or the light incident side chamfering surface 57.

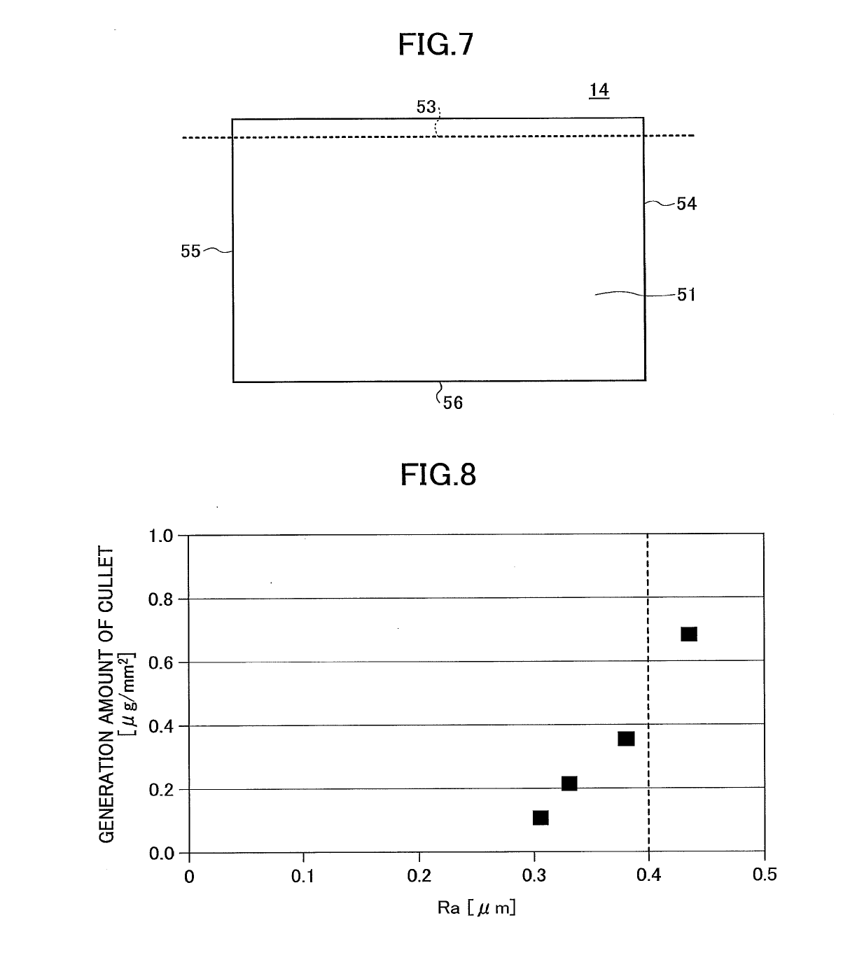

When the first chamfering process (step S12) ends, the mirror finishing process (step S14) is performed. In the mirror finishing process, as illustrated in FIG. 7, the mirror finishing process is performed on the light incident side surface of the glass base material 14, and thereby the light incident surface 53 is formed. As described above, the light incident surface 53 is a surface that light enters from the light source 4. Therefore, the light incident surface 53 is subjected to the mirror finishing so that a surface roughness Ra is less than 0.03 μm.

When the light incident surface 53 is formed on the glass base material 14 at the mirror finishing process (step S14), by performing the second chamfering process (step S16), and by performing the cutting process or the polishing process between the light emission surface 51 and the light incident surface 53 and between the light reflection surface 52 and the light incident surface 53, the light incident side chamfering surface 57 (chamfering surface) is formed. The process at step S16 may be performed before step S14, or may be performed simultaneously with step S14.

In the second chamfering process, when an average value of the width dimension X of the light incident side chamfering surface 57 in the longitudinal direction is Xₐᵥₑ, the chamfering surface is formed so that an error of X in the longitudinal direction is 50% of Xₐᵥₑ or less, and the surface roughness Ra is 0.4 μm or less.

Upon forming the light incident side chamfering surface 57, as a tool for performing the cutting process or the polishing process, a grinding stone may be used. Moreover, instead of the grinding stone, a buff or brush including cloth, leather, rubber or the like may be used. In this case, an abrasive, such as cerium oxide, alumina, carborundum, or colloidal silica, may be used.

By performing the respective processes indicated by steps S10 to S16, the light guide plate 5 is manufactured. The reflection dots 10A to 10C, described as above, are printed on the light reflection surface 52 after the light guide plate 5 is manufactured.

Incidentally, during each process of the cutting process, the chamfering process, the mirror finishing process and the like, performed upon manufacturing the light guide plate 5, described as above, a glass waste (cullet) is generated from the glass material 12 and the glass base material 14. Because the cutting process and the first chamfering process are processes with low accuracy compared with the mirror finishing process and the second chamfering process, the generated cullet is relatively large and does not easily adhere to the light guide plate 5.

Because the mirror finishing process and the second chamfering process are processes with high accuracy, the generated cullet is smaller than the cullet generated in the cutting process or the first chamfering process. Therefore, the cullet generated in the mirror finishing process or the second chamfering process is liable to adhere to the light guide plate 5.

Furthermore, because the mirror finishing process and the second chamfering process are processes for the light incident surface 53 and the light incident side chamfering surface 57, the cullet generated in the mirror finishing process or the second chamfering process is liable to adhere near the light incident surface 53 or the light incident side chamfering surface 57.

At a site near the light incident surface 53 and the light incident side chamfering surface 57, as illustrated in FIG. 2, the reflection dots 10A with small diameter L_{A} are formed. That is, the region where the reflection dots 10A are formed is a region having a wide area in which the glass of the light guide plate 5 is exposed.

Furthermore, because a cullet is a glass waste, as described above, the cullet has a property of reflecting light.

Therefore, an amount of reflection for light entering from the light source 4 changes significantly (the amount of reflection increases) when a cullet adheres to the region, in which the reflection dots 10A are formed, compared with the case where a cullet adheres to the region, in which the reflection dots 10B, 100 are formed. Accordingly, particularly when a cullet adheres to the region, in which the reflection dots 10A are formed, the luminance unevenness generated in the light guide plate 5 is great.

In order to prevent the luminance unevenness from being generated in the region in which the reflection dots 10A are formed, it is necessary to reduce an amount of generation of cullet that is generated upon processing the light incident surface 53 and the light incident side chamfering surface 57. In the processing for the light incident side chamfering surface 57 that is a chamfering process, the amount of generation of cullet is greater than the processing for the light incident surface 53 that is subjected to the mirror finishing process.

Then, the inventors of the present invention performed an experiment for measuring the amount of generation of cullet in the processing of the light incident side chamfering surface 57. Moreover, in the experiment, when a processing accuracy for the light incident side chamfering surface 57 is changed, the surface roughness Ra of the diffusion sheet 7 changes. A correlation relation between the surface roughness Ra of the light incident side chamfering surface 57 and the amount of generation of cullet was investigated.

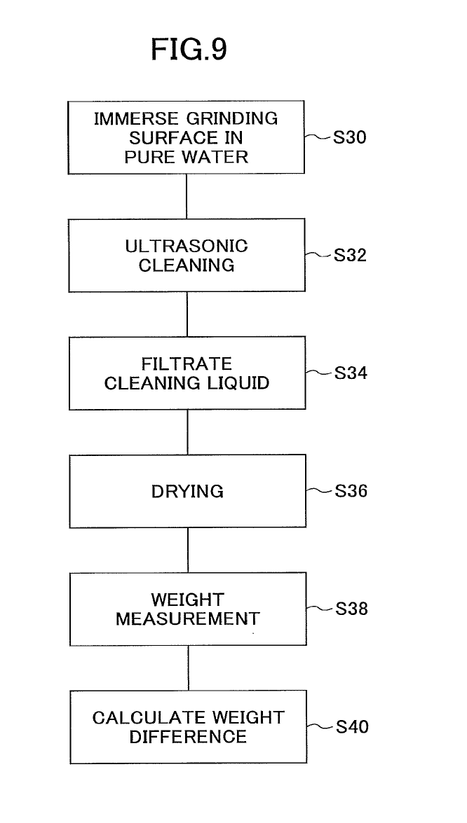

The amount of cullet generated upon performing the light incident side chamfering surface 57 was determined using the following method. FIG. 9 is a flowchart depicting a method for determining the amount of the generated cullet.

In order to determine the amount of cullet generated upon performing the chamfering process for the light incident side chamfering surface 57, a beaker filled with pure water was prepared, and the light incident side chamfering surface 57 of the light guide plate 5, which was subjected to the chamfering process, and neighborhood thereof are immersed in the pure water (step S30).

By performing the chamfering process, a cullet adhered to the light incident side chamfering surface 57 and neighborhood thereof. Therefore, the cullet adhering to the light incident side chamfering surface 57 or the like was also immersed in the pure water.

Next, by causing the beaker to perform an ultrasonic vibration, the light incident side chamfering surface 57 of the light guide plate 5 was subjected to an ultrasonic cleaning (step S32). By performing the ultrasonic cleaning, the cullet adhering to the light incident side chamfering surface 57 or the neighborhood thereof, fell to the bottom of the beaker and is accumulated. The pure water in which the cullet falls will be referred to as “cullet water”).

Next, the cullet water, prepared at step S32, was filtrated by a filter, whose weight had been measured in advance (step S34). According to the configuration, the cullet was collected by the filter. The filter that collected the cullet was subjected to a drying process by using a drying machine (step S36).

Next, after the filter was sufficiently dried, the weight of the filter was measured (step S38). By subtracting the weight of the filter that had been measured in advance from the weight measured at step S38, the amount of cullet generated upon performing the chamfering process for the light incident side chamfering surface 57 can be obtained (step S40).

FIG. 8 is a diagram depicting a relation between the surface roughness Ra of the light incident side chamfering surface 57 and the amount of generated cullet (mass of cullet generated per 1 mm²). From FIG. 8, it is found that the amount of generated cullet correlates with the surface roughness Ra, in the range where the surface roughness Ra of the light incident side chamfering surface 57 is greater than 0.3 μm.

In the experiment, the light incident surface 53 was also immersed in the pure water, in addition to the light incident side chamfering surface 57. However, contribution from the light incident surface 53 immersed in the pure water to the correlation relation between the amount of generated cullet and the surface roughness Ra was negligible. This is because the surface roughness Ra of the light incident surface 53 according to the embodiment was less than 0.03 μm, and from FIG. 8, the amount of cullet generated on the light incident surface 53 was small.

The inventors of the present invention calculated an amount of generated cullet at which the luminance unevenness occurs when a cullet adheres to the light incident side chamfering surface 57.

When a diameter of the cullet is 100 μm or more, the light emission characteristics of the light guide plate 5 is affected (luminance unevenness or the like). Moreover, as described above, an adhesion position of cullet that affects the optical characteristics of the light guide plate 5 is the region in which the reflection dots 10A with small diameter (L_{A}) are formed. An area of the region in which the reflection dots 10A are formed is approximately 10% of the whole area of the light guide plate 5.

Furthermore, in the sheet-like light emitting device 3, when the luminance unevenness greater than 3% occurs in the light guide plate 5, display quality of the liquid crystal display device 1 is deteriorated greatly. Therefore, the luminance unevenness occurring in the region, in which the reflection dots 10A with small diameter are formed, is preferably 3% or less.

Based on the above-described conditions, the amount of generated cullet, at which the luminance unevenness is not affected, will be calculated.

A specific weight of the glass material 12 is assumed to be 2.5 g/cm³. Then, a weight W of a cullet having a diameter of 100 μm is W=1.31×10⁻³ μg.

Moreover, assuming that the size of the light guide plate 5 is (light incident surface) L mm×(non-light incident surface) H mm, and an average value of the width of the light incident side chamfering surface 57 in the longitudinal direction is Xₐᵥₑ mm, an area Sₐ of the light incident side chamfering surface 57 is obtained by the following formula (1):

Sₐ=√2×2×L×Xₐᵥₑ mm² (1)

Furthermore, an area of the region in which the reflection dots 10A are formed (the region that affects the luminance unevenness when a cullet adheres) is approximately 10% of the whole area of the light guide plate 5. The area S_{b} mm² in which the reflection dots 10A are formed is obtained by the following formula (2):

S_{b}=0.1×L×H mm² (2)

When the amount of generated cullet is c μg/mm², a number of pieces of generated cullet having a diameter of 100 μm, that occurs from the light incident side chamfering surface 57 is obtained by c×Sₐ/W.

Assuming that all the cullet generated as above adhere to the region in which the reflection dots 10A are formed, in order to make the luminance unevenness 3% or less, a fraction of an area covered by the cullet adhering to the region in which the reflection dots 10A are formed in the area Sb is required to be 3% or less. That is the following formula (3) is required to be satisfied:

(c×Sₐ/W×50²×π)/S_{b})≦0.03 (3)

Because the width of the light incident side chamfering surface 57 is proportional to Sₐ according to formula (1), also in order to sufficiently increase the area of the light incident surface 53, a relation S_{b}/Sₐ≧100 is preferably satisfied. Therefore, in order to always satisfy the above formula (3) and the relation S_{b}/Sₐ≧100, the amount of generated cullet c preferably satisfies the following formula (4):

c≦100×0.03×W/(50²×π) (4)

The amount of generated cullet c satisfying the above-described formula (4) is 0.5 μg/mm² or less.

With reference to FIG. 8, when the amount of generated cullet is 0.5 μg/mm² or less, the surface roughness Ra of the light incident side chamfering surface 57 is 0.4 μm or less. Therefore, it is demonstrated that the light guide plate 5 in which the luminance unevenness does not occur can be enabled by making the surface roughness Ra of the light incident side chamfering surface 57 0.4 μm or less.

The greater the width dimension X of the light incident side chamfering surface 57 is, the greater the amount of generated cullet is. In such a case, also in order to make the amount of generated cullet be 0.5 μg/mm², the surface roughness Ra of the light incident side chamfering surface 57 is preferably 0.3 μm or less, more preferably 0.1 μm or less, and further preferably 0.03 μm or less.

As described above, the preferred embodiments of the present invention have been described in detail. However, the present invention is not limited to the above-described specific embodiments, but various variations and modifications may be made without deviating from the scope of the present invention.

What is claimed is:

1. A glass comprising:
a first surface;
a second surface that faces the first surface;
at least one first end surface arranged between the first surface and the second surface; and
at least one first chamfering surface connecting the first surface or the second surface with the first end surface, a surface roughness Ra of the first chamfering surface being 0.4 μm or less.

2. The glass according to claim 1,
wherein when an average value of a width X of the first chamfering surface in a longitudinal direction is Xₐᵥₑ mm, an error in the width X of the first chamfering surface in the longitudinal direction is 50% of Xₐᵥₑ mm or less.

3. The glass according to claim 1 further comprising:
at least one second end surface between the first surface and the second surface, the second end surface being different from the first end surface; and
at least one second chamfering surface connecting the first surface or the second surface with the second end surface, a surface roughness Ra of the second chamfering surface being greater than the surface roughness Ra of the first chamfering surface but less than or equal to 1.5 μm.

4. The glass according to claim 3,
wherein when an average value of a width Y of the second chamfering surface in a longitudinal direction is Yₐᵥₑ mm, an error in the width Y of the second chamfering surface in the longitudinal direction is 50% of Yₐᵥₑ mm or less.

5. The glass according to claim 3,
wherein a surface roughness Ra of the second end surface is 1.5 μm or less.

6. The glass according to claim 3,
wherein the first surface has a rectangular shape,
wherein the glass includes at least three second end surfaces arranged between the first surface and the second surface, the second end surfaces being different from the first end surface,
wherein the glass includes at least three second chamfering surfaces connecting the first surface or the second surface with the second end surfaces, respectively, and
wherein any of the surface roughness Ra of the second chamfering surfaces is greater than the surface roughness Ra of the first chamfering surface but less than or equal to 1.5 μm.

7. The glass according to claim 1,
wherein an amount of cullet generated on the first chamfering surface is 0.5 μg/mm².

8. The glass according to claim 1,
wherein an effective optical path length is 5 cm or more but 200 cm or less, and
wherein an average internal transmittance in a visible light region at the effective optical path length is 80% or more.

9. The glass according to claim 1,
wherein an average internal transmittance in a region, in which a wavelength is 400 nm or more but 700 nm or less, under a condition of an effective optical path length of 50 mm, is 90% or more.

10. A manufacturing method of a glass comprising:
preparing a glass base material including a first surface and a second surface that face each other, and at least one first end surface and at least one second end surface that are arranged between the first surface and the second surface;
chamfering the second end surface of the glass base material;
performing a mirror finishing process for the first end surface; and
forming at least one first chamfering surface connecting the first surface or the second surface with the first end surface by chamfering the first end surface of the glass base material having been subjected to the mirror finishing process, a surface roughness Ra of the first chamfering surface being 0.4 μm or less.
